(19) United States
(12) Patent Application Publication
(10) Pub. No.: US 2016/0342643 A1
(43) Pub. Date: Nov. 24, 2016

(54) System and Method for Cleansing Website Traffic Data

(71) Applicant: NIKE, Inc., Beaverton, OR (US)

(72) Inventor: Craig Rowley, Beaverton, OR (US)

(21) Appl. No.: 15/159,502

(22) Filed: May 19, 2016

Related U.S. Application Data
(60) Provisional application No. 62/165,536, filed on May 22, 2015.

(51) Int. Cl. G06F 17/30; H04L 12/26; H04L 29/08

(52) U.S. Cl. CPC G06F 17/30371; H04L 67/22; H04L 67/02; H04L 43/062; G06F 17/30899

(57) ABSTRACT

Systems and methods for analyzing and filtering website traffic data for determining website visitor habits and behaviors, and for enhancing computer-based marketing activities. More specifically, the present disclosure provides systems for filtering and summarizing large element datasets.

### CROSS-REFERENCE TO RELATED APPLICATIONS

This application claims priority to U.S. Provisional Patent Application No. 62/165,536, filed on May 22, 2015, which is expressly incorporated herein by reference in its entirety for any and all non-limiting purposes.

### TECHNICAL FIELD

The present disclosure relates generally to systems and methods for cleansing website traffic data for determining website visitor habits and behaviors and for enhancing computer-based marketing activities. More specifically, the present disclosure relates to a system for high-frequency filtering and analysis of large element datasets.

### BACKGROUND

Analyzing website visitor habits and behaviors may enhance a company's marketing activities. To do so, companies may measure and extract large amounts of data associated with website traffic, and then attempt to analyze the large volumes of data to determine, for example, what products are selling with high popularity, what products are not selling with high popularity, and the factors that are driving product sales. Website traffic data can come from many website entry sources, including social media, search engines, referrals, Email, paid searches and from direct traffic. Examples of the data extracted and analyzed include; 1) page views, 2) visits, 3) conversion rate, 4) bounce rate, 5) time on page, 6) view/visit ratio, 7) page entrance rate, and 8) page exit rate.

Existing marketing software tools can monitor website traffic, collect large volumes of website traffic data and store the website traffic data as data frames in columnar data files, where the columns have a header and one observation or event (“content”) in each row. A data frame, or rectangle, is a data structure that has at least the following qualities; 1) the same number of columns on every row, 2) uses the same delimiter to separate columns (e.g. tab or comma), and 3) uses the same delimiter to separate lines (e.g. newline and/or carriage-return). Comma-separated value files (CSV) or tab-delimited files are typical for storing data frames on a storage medium, e.g. a storage disk. Examples of applications that can save data in the CSV or tab-delimited formats include Microsoft Excel which can save tabular data in the CSV format. Apache Hive®, open source data warehouse software that facilitates querying and managing large datasets residing in distributed storage environments, can export query results as a delimited file, but Hive typically uses the “CTRL-A” character as the field delimiter since tabs and commas commonly appear in unstructured, freeform text data. Similarly, Cloudera Impala, open source software enabling users to issue low-latency SQL queries to data stored in the Hadoop distributed file system and Apache Hbase.

Omniture software, now part of the Adobe Marketing Cloud, is one such marketing software tool. For an average website, the website traffic data collected on a daily basis can be in the millions of rows, e.g., 100 millions of rows, where each row has a large number of columns, e.g. over 500 columns. Because website traffic data comes from many sources via different platforms, (e.g., mobile platforms) the website traffic data may be tagged differently by such existing marketing software such that there are no standardized field names and the content in each field may differ. As a result of the inconsistencies in the tagging of website traffic data, and the storage of the large daily volume of website traffic data in row based files, the processing and analyzing of website traffic data is a complex endeavor taking days and often weeks.

Exploratory data analysis (EDA) is employed to process and analyze such large volumes of columnar based website traffic data files. The primary goal of EDA is to maximize an analyst's insight into a dataset and into the underlying structure of a dataset, while providing specific items that an analyst would want to extract from a dataset in order to observe trends. However, the processing and analyzing columnar based data files may take days or more often weeks.

### BRIEF SUMMARY

The present disclosure provides systems and methods for cleansing website traffic data for determining website visitor habits and behaviors, and for enhancing and optimizing computer based marketing activities. More specifically, the present disclosure provides systems capable of filtering and summarizing large element datasets in relatively short periods of time, processing any delimited data rectangle and outputting a set of data reports that facilitate facile review by a human user. In one embodiment, the data cleansing system may include a transformer, an entropy filter module, a summarizing engine, a detector and a reporting engine. The transformer may transpose a columnar dataset to an analytic dataset that enables row-based data processing. The filter module may be utilized to filter low entropy variables out of the analytic dataset to provide a filtered analytic dataset. The summarizing engine may classify each variable in the filtered analytic dataset to form a classified analytic dataset. The detector may detect duplicate variables and correlated variables in the classified analytic dataset.

In one aspect, this disclosure relates to an apparatus, a method, and a non-transitory computer-readable medium for cleansing website traffic data, and includes transposing a columnar dataset to an analytic dataset that enables row-based data processing, filtering low entropy variables out from the analytic dataset to provide a filtered analytic dataset, classifying each variable in the filtered analytic dataset to form a classified analytic dataset, and detecting duplicate variables and correlated variables in the classified analytic dataset. The an apparatus, method, and non-transitory computer-readable medium may also include reporting results from the classified analytic dataset. Transposing a columnar dataset includes performing a piecewise transpose process on the columnar dataset wherein each row in the columnar dataset is arranged as a separate column. A horizontal combine is used to arrange each separate column from the piecewise transpose process as a row to form the analytic dataset. Filtering low entropy variables includes analyzing the analytic dataset one variable at a time to remove variables determined to have insufficient entropy from the analytic dataset. Classifying each variable in the filtered analytic dataset includes processing each variable to determine a frequency distribution for variable element values, and classifying each variable as continuous or categorical depending upon a number of bins in the frequency distribution when compared to a categorical threshold parameter value. Detecting duplicate variables and correlated variables includes determining correlation coefficients of frequency distributions to establish variable colinearity and comparing the distributions with potential matches.

### BRIEF DESCRIPTION OF THE DRAWINGS

The figures depict embodiments for purposes of illustration only. One skilled in the art will readily recognize from the following description that alternative embodiments of the structures and methods illustrated herein may be employed without departing from the principles described herein, wherein:

FIG. 1 shows an illustrative operating environment in which various aspects of the disclosure may be implemented.

FIG. 2 is a schematic block diagram of a system for collecting website traffic data and for cleansing collected website traffic data for analysis, according to one or more aspects described herein.

FIG. 3 schematically depicts a functional block diagram of a web site traffic data cleansing system, according to one or more aspects described herein.

FIG. 4 schematically depicts a scalable transpose process of the website traffic data cleansing system, according to one or more aspects described herein.

FIG. 5 schematically depicts a process for detecting co-linearity of website traffic data of the website traffic data cleansing system, according to one or more aspects described herein.

FIG. 6 is an exemplary report generated by the website traffic data cleansing system, according to one or more aspects described herein.

FIGS. 7A and 7B depict another exemplary report generated by the website traffic data cleansing system, according to one or more aspects described herein.

FIGS. 8A and 8B depict another exemplary report generated by the website traffic data cleansing system, according to one or more aspects described herein.

FIGS. 9A and 9B depict another exemplary report generated by the website traffic data cleansing system, according to one or more aspects described herein.

FIG. 10 is a flowchart diagram of a process for cleansing website traffic, according to one or more aspects described herein.

FIG. 11 schematically depicts an exemplary website traffic data cleansing system, according to one or more aspects described herein.

### DETAILED DESCRIPTION

The present disclosure describes a data cleansing system and method that processes, analyzes, and cleanses large volumes of data associated with online commerce activity (hereinafter referred to “website traffic data”) to determine trends and desired information about website visitor habits and behaviors.

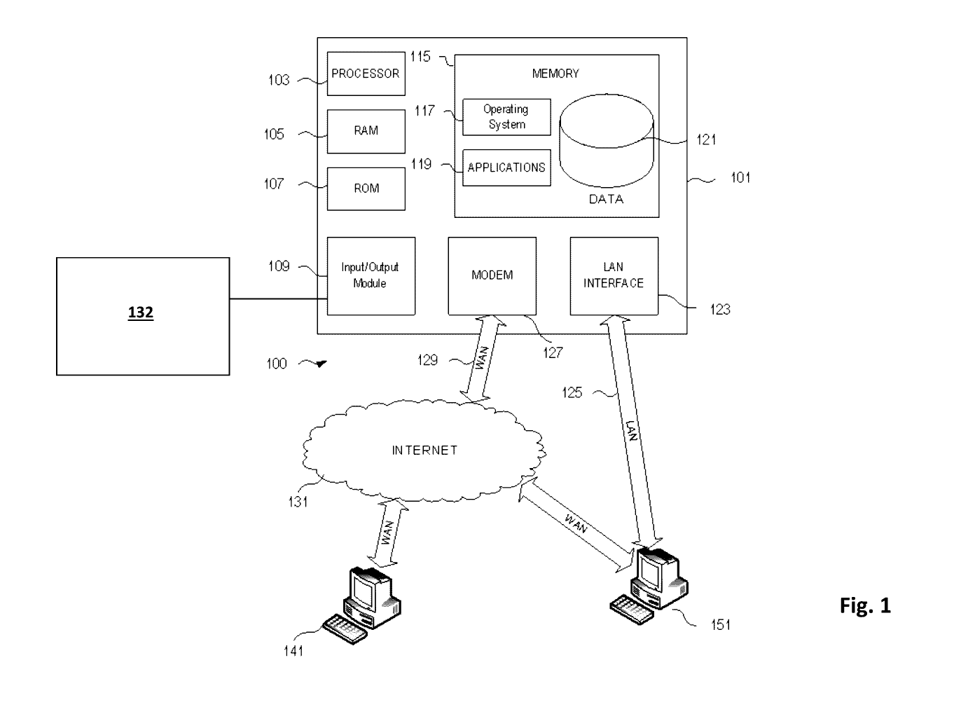

FIG. 1 depicts an exemplary website traffic data cleansing system 100. The website traffic data cleansing system 100 includes a management module 101, which is shown in this example as a computing device. The computing device 101 may comprise specialized hardware configured to execute processes described in relation to one or more embodiments disclosed herein, including depicted in one or more of the proceeding figures (or combinations thereof) that may execute the website traffic data cleansing system 100. In one example, the website traffic data cleansing system 100 necessitates complex processes to be executed at high frequencies that are beyond the capabilities of mental processes, and utilizing, in one example, the application-specific hardware associated with the computing device 101. In one specific example, the systems and methods described herein may be utilized to process multiple millions of pieces of information associated with internet traffic in order to execute one or more analyses. As such, one of ordinary skill in the art will recognize that the systems and methods described herein require, in one example, the computational hardware associated with a computing device 101. Accordingly, the computing device 101 may include a processor 103 for controlling overall operation of the computing device 101 and its associated components, including RAM 105, ROM 107, an input/output (I/O) module 109, and memory 115. In certain examples, the processor 103 may execute computational instructions in series or in parallel, and with a computational frequency ranging from multiple megaFLOPS to multiple teraFLOPS or more.

I/O module 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to the processor 103 for enabling the computing device 101 to perform various functions. For example, memory 115 may store software used by the computing device 101, such as an operating system 117, application programs 119, and an associated database 121. The processor 103 and its associated components may allow the computing device 101 to run a series of computer-readable instructions to collect as well as analyze website traffic data in order to determine website visitor habits and behaviors.

The computing device 101 may operate in a networked environment supporting connections to one or more remote computers, such as devices 141 and 151. The devices 141 and 151 may be personal computers, smartphones, tablets, or servers that include many or all of the elements described above relative to the computing device 101. Additionally, devices 141 and 151 may include various other components, such as a battery, speaker, and antennas (not shown). Alternatively, devices 141 and/or 151 may be a data store that is affected by the operation of the computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed. Accordingly, communication between one or more of computing devices 101, 141, and/or 151 may be wired or wireless, and may utilize Wi-Fi, a cellular network, Bluetooth, infrared communication, or an Ethernet cable, among many others.

Additionally, an application program 119 used by the computing device 101 according to an illustrative embodiment of the disclosure may include computer-executable instructions for invoking functionality related to collecting as well as analyzing website traffic data for determining website visitor habits.

Further, system 100 may comprise a controlled device 132 that is connected to the computing device 101, and controlled by the processor 103. As such, the controlled device 132 may be wired or wirelessly-connected to the computing device 101 and may comprise specialized hardware, firmware, and/or software configured to execute processes responsive to instructions received from the processor 103.

The disclosure is operational with numerous other special-purpose computing system environments or configurations that facilitate computational frequencies and complexities beyond that of mere mental processes or prior capabilities.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

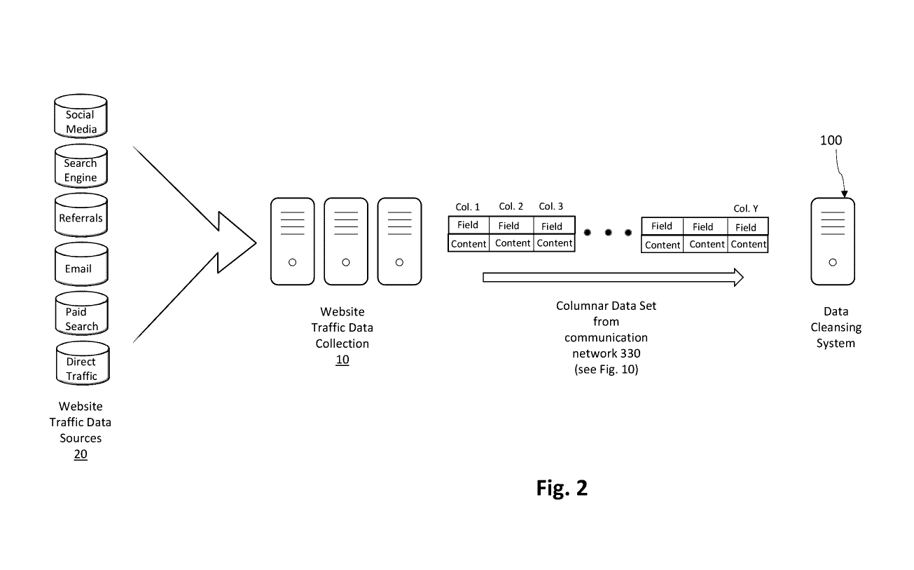

FIG. 2 schematically depicts website traffic data that may be analyzed using the website traffic data cleansing system 100 described in relation to FIG. 1. In one implementation, existing online monitoring processes executed by, for example, servers 10 may monitor website traffic and collect and store large volumes of data in columnar based files from various website entry sources 20, such as, among others: social media websites, website search engines, website referrals, Email links to websites, paid website searches, and from direct website traffic, or combinations thereof. In one example of website traffic data volume, for an average website, the data collected on a daily basis may include millions of rows (e.g., 90 million rows), where each row may have a large number of columns (e.g. over 550 columns). Although the above example provides a number of rows and columns, these are not a limit to the number of rows and columns that can be processed and analyzed by the system and method of the present disclosure. The large volume of columnar based files are then passed to the data cleansing system 100 according to the present disclosure.

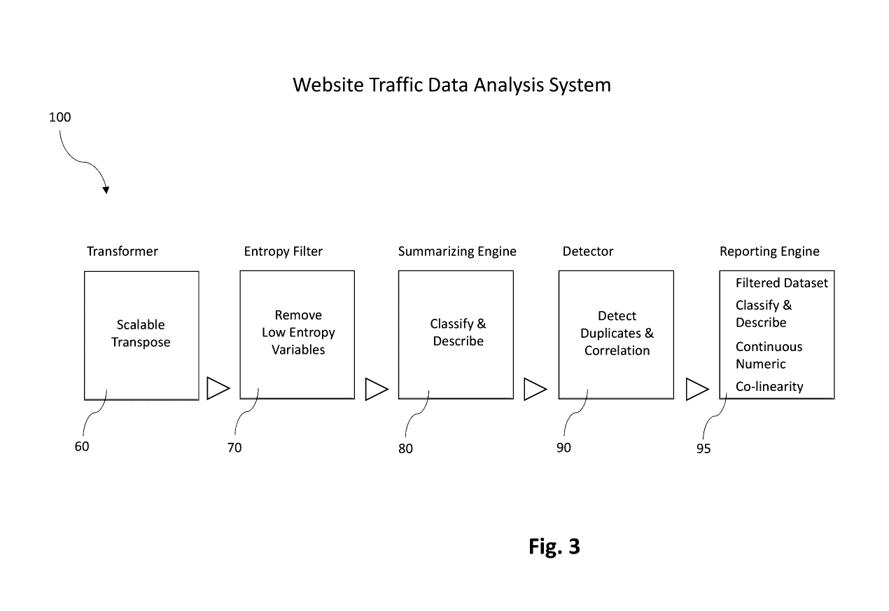

In certain examples, website traffic data may be received from different website entry sources. As such, website traffic data may be tagged with fields having different names and the observation or event (i.e., the content) in each field may differ. Advantageously, the data cleansing system 100 of the present disclosure may significantly reduce the time and computational resources needed to process the large volumes of website traffic data collected. In one exemplary embodiment, as schematically depicted in FIG. 3, the data cleansing system 100 may include a transformer 60, a filter 70, a summarizing engine 80, a detector 90 and a reporting engine 95. Accordingly, one or more of the transformer 60, filter 70, summarizing engine 80, detector 90, and/or reporting engine 95 (which may otherwise be referred to as transformer module 60, filter module 70, summarizing engine module 80, detector module 90, and reporting engine module 95) may comprise specialized hardware, firmware and/or software implemented as the controlled device 132, or the within memory 115, as described in relation to FIG. 1.

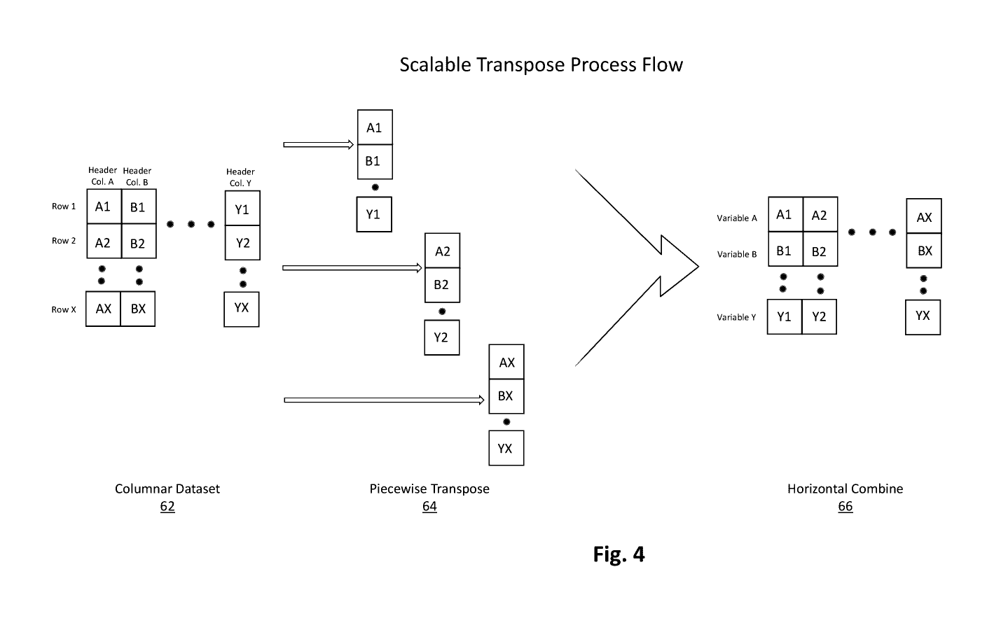

In one implementation, the transformer 60 may execute one or more processes that transpose columnar website traffic data to enable row-based processes to be executed on the columnar data. The one or more transpose processes may also be referred to herein as “scalable transpose” processes. In one example, the scalable transpose processes may be utilized with any size data frame based columnar input file. Referring to FIG. 4, the transformer 60 may start with the columnar dataset 62 from an external source, e.g., a marketing software tool. In the exemplary embodiment shown, there are A-Y columns, where A1 represents the first column in the dataset and Y1 is the last column in the dataset. As noted above, the number of columns can be very large, for example Y1 could represent 500 columns. However, it is contemplated that any number of columns may be utilized, without departing from the scope of these disclosures. In addition, there may be A-X rows, where A1 represents the first row in the data set and AX represents the last row in the data set. As noted above, the number of rows can be very large, for example AX could represent 120 million rows. However, it is contemplated that any number of rows may be utilized, without departing from the scope of these disclosures. In one example, each column may have a header and one observation or event (“content”) in each row. The transformer 60 may execute one or more processes to receive the columnar dataset and perform a piecewise transpose operation where each row, e.g., A1-Y1, is arranged in a column. Accordingly, in one example, and as shown in FIG. 4, row A1-Y1 is arranged as a separate column, row A2-Y2 is arranged as a separate column, and this piecewise transpose occurs until row AX-YX is arranged as a separate row. Once the piecewise transpose process is completed, the separate columns may be combined horizontally 66 to form a resulting transpose dataset, where A1-AX is in a row, B1-BX is in a row, and this horizontal combine occurs until row Y1-YX. As shown in FIG. 4, the resulting transpose dataset may have one row per column and one field per row. As a result, each row may be very large. However, because the transpose dataset has one field per row, one or more row-based processes may be executed on the resultant data.

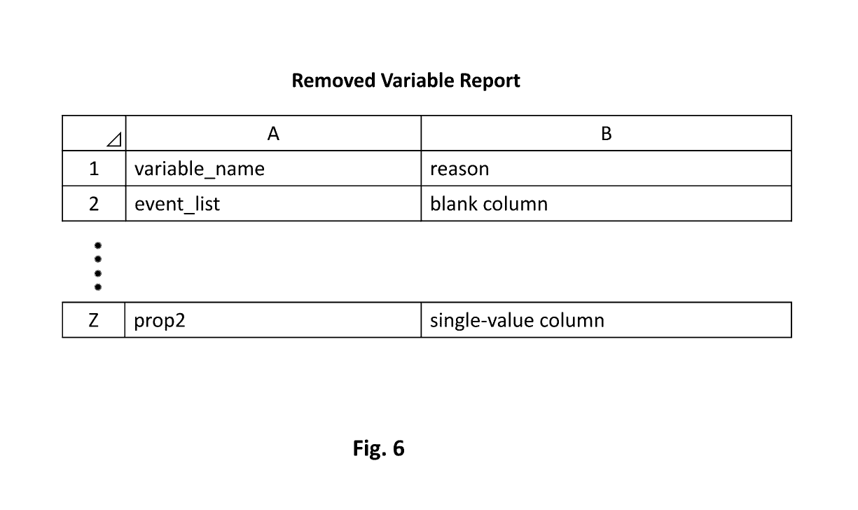

The filter 70 may execute one or more processes using the resulting transposed data (also referred to herein as the analytic dataset). The processes may be executed one variable (i.e., one row) at a time to filter variables found to have insufficient entropy (i.e., in one example, less than an average amount of information contained in each variable). If a variable is found to have insufficient entropy, the variable may be added to a “removed” list and may be removed from the resulting analytic dataset. For the purpose of the present disclosure, a variable having insufficient entropy may include a variable that does not have at least two distinct values. In another example, a variable having insufficient entropy may include a variable that does not have at least three distinct values. However, it is contemplated that any definition of insufficient entropy with regard to a number of distinct values may be utilized, among others, without departing from the scope of these disclosures. In one example, for each variable, the filter 70 may execute one or more processes to iterate through the elements in each row and determine if there are at least two distinct values across the entire row. For example, if variable A (in FIG. 4) is “gender” then the value of each element in the row may be either “female” or “male.” If, during the one or more filter processes, the variable “gender” is determined to correspond to “female” for each element in the row, then the filter 70 may determine that the variable A had insufficient entropy and would add the variable A to the remove list reported in FIG. 6.

The summarizing engine 80 may execute one or more processes using variables received from the entropy filter 70. Further, the summarizing engine 80 may execute one or more processes using each variable to determine a distribution calculated for the variable element values. Based upon the distribution of each variable element, the variables may be classified as “continuous” or “categorical,” which may be based on the number of bins in the frequency distribution when compared to a categorical threshold, e.g., “cat_thresh,” parameter value. The variable data type is also classified according to type, e.g. “numeric” or “character” based upon the presence of non-numeric characters in the data stream. The summarizing engine 80 may execute one or more processes to generate parametric summaries for all variables that pass through the entropy filter 70. For continuous variables, the summarizing engine 80 may also describe their distribution using statistical comparison tests, e.g. Shapiro-Wilk test for normality, or the Anderson-Darling tests for comparisons against more types of distributions, and critical percentile breakouts using one or more sorting processes to order the data and then dynamically compute any number of percentiles of interest. In one example, each categorical variables' levels, i.e. discrete values, may be quantified as a percentage of the entire distribution and described by outputting example values.

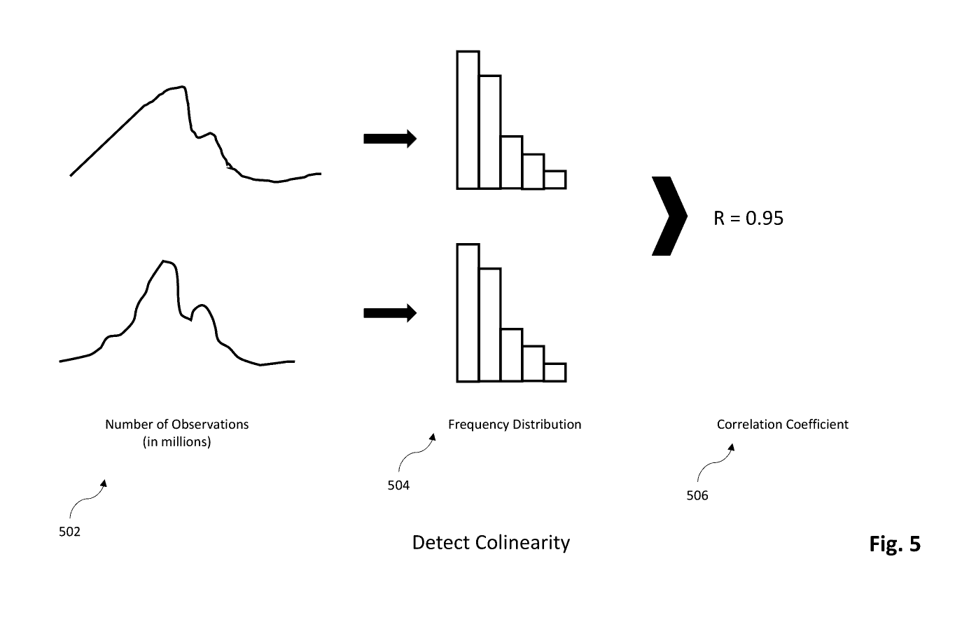

The detector 90 may execute one or more processes to determine correlation coefficients of frequency distributions to establish variable colinearity, as demonstrated by the process flow shown in FIG. 5. In particular, raw data that includes, in some examples, large numbers of website traffic observations (data points) that may be received by the computing device 101. These observations are schematically depicted as element 502 in FIG. 5. The computing device 101, may subsequently described the variables within the received data as a frequency distribution, as schematically depicted by element 504 in FIG. 5. Additionally, the computing device 101 may calculate a correlation coefficient of the frequency distribution. The correlation coefficient of 0.95 schematically depicted in FIG. 5 as element 506 is one example of a result of these one or more calculation processes. In one implementation, both duplicates and correlated variables may be detected by direct comparison, or by a rules engine. In cases where only a few unique values exist, a direct comparison may be used. In one implementation, the unique values of a large data set may not be compared simultaneously due to limiting factors, e.g. cost, time, space, computing resources. In such instances, a rules engine may be employed that uses previously computed distribution descriptors to identify potential matches, and to compare the distributions of each variable with the potential matches. In one implementation, it is contemplated that a heuristic process used may be similar to a heuristic employed to perform pattern matching from a distance, e.g. analog facial recognition, which may first summarize a desired object by a set of key features to quickly reduce the search space, and then perform a full-detail match on the lesser number of potential matches.

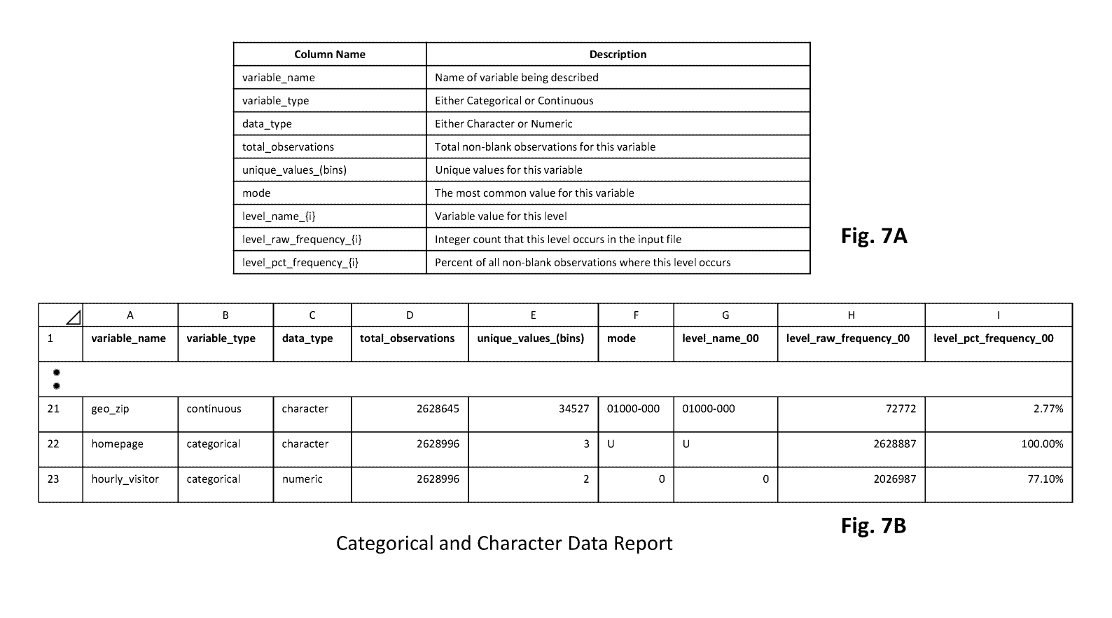

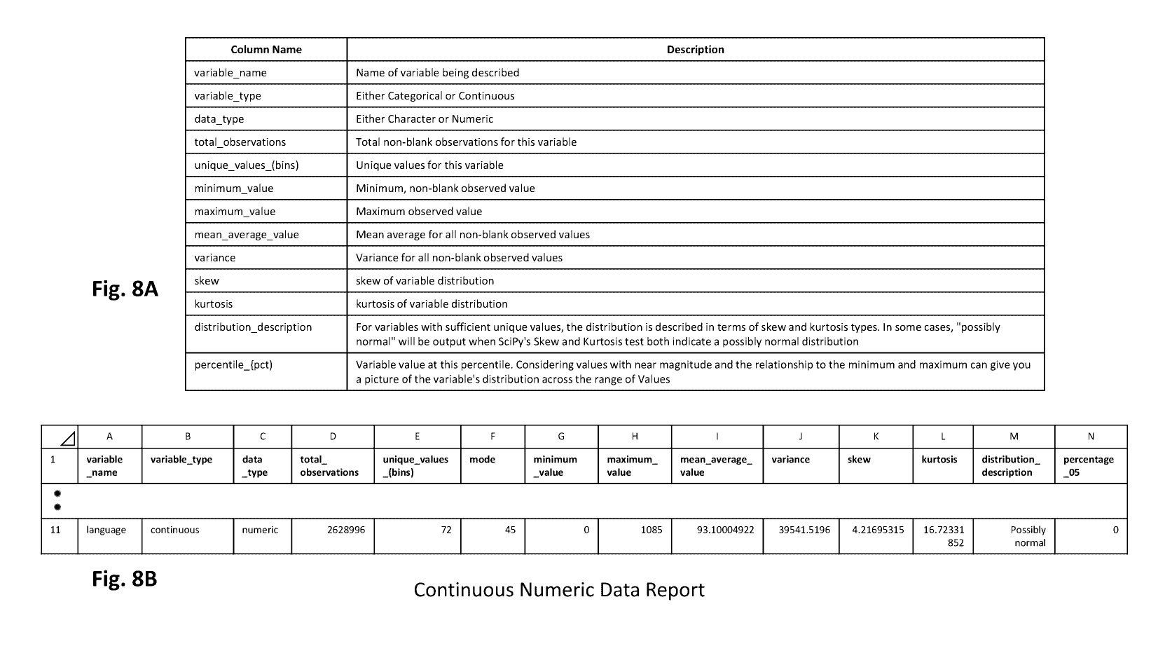

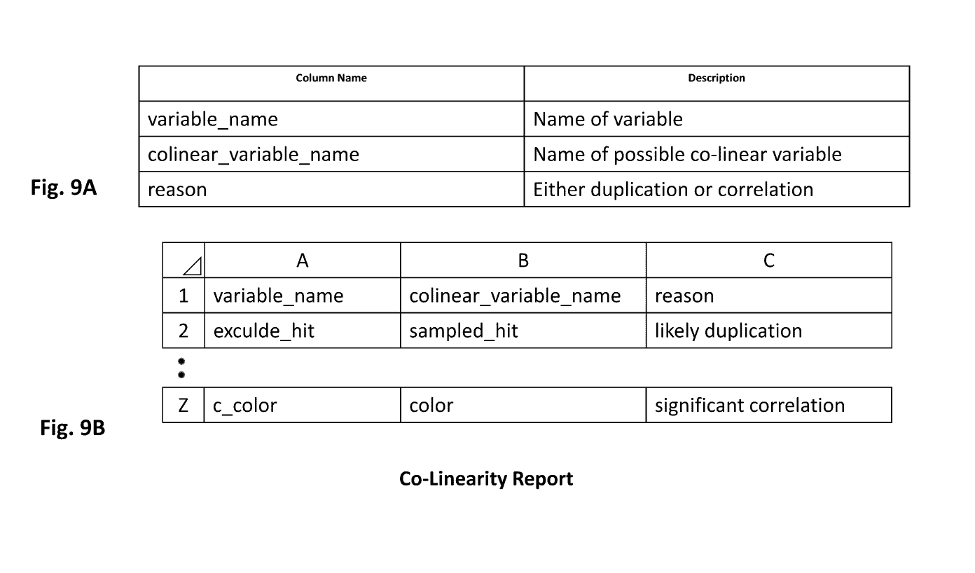

The reporting engine 95 may execute one or more processes to generate reports relating to, for example, the variable collinearity. In one implementation, these reports may allow a data analyst (e.g. a data analyst module) to execute decision-making processes to determine which variables should be removed from the dataset. For example, FIGS. 7A and 7B provide a categorical and character data report listing a plurality of variables, e.g., “geo zip,” with variable types as “categorical” and/or data types as “character” and information and values associated with the variables. As another example, FIGS. 8A and 8B provide a continuous numeric data report listing a plurality of variables, e.g., “language,” with a variable type as “continuous.” As another example, FIGS. 9A and 9B provide a co-linearity report listing a plurality of variables, e.g., “c_color,” a possible collinear variable name, e.g., “color,” and a reason for the colinearity, e.g., “significant correlation.”

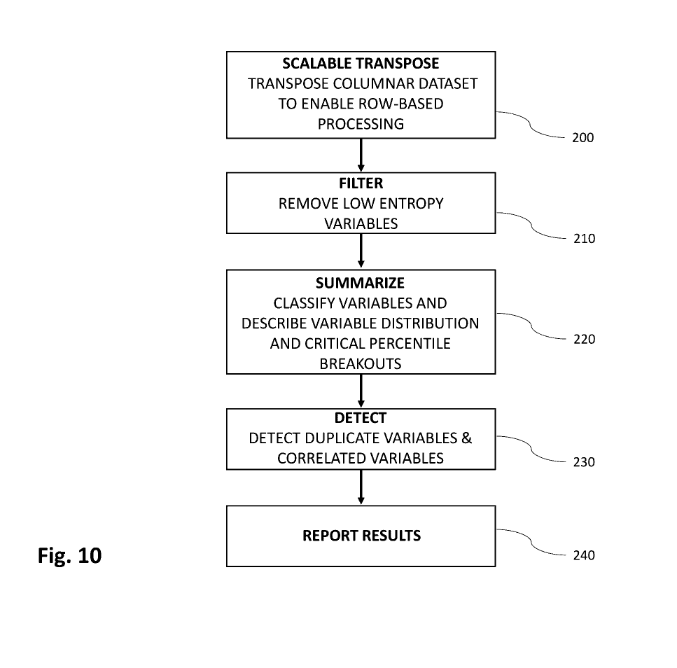

FIG. 10 schematically depicts a flowchart diagram of one or more processes utilized to cleanse website traffic data. Accordingly, the one or more processes associated with the flowchart of FIG. 10 may be executed by the computing device 101, as described in relation to FIG. 1. In one example, website traffic data in columnar form may be transposed into a row-based format where row based processing functions may be performed on the dataset using the above described scalable transpose process. These one or more transposing processes may be executed at block 200. The resulting transposed dataset may be filtered to remove low entropy variables. These one or more filtering processes may be executed at block 210. Subsequently, the dataset may be summarized by the summarizing engine 80 to classify the variables that pass through the entropy filter 70. Additionally, one or more processes may output data indicating the variable frequency distribution and identifying critical percentile breakouts. These one or more processes may be executed at block 220. Further, one or more processes may be executed on the data to determine variable co-linearity by calculating correlation coefficients of frequency distribution of each variable. Additionally, duplicated and correlated variables may be detected and removed from the dataset. The result is a dataset that is ready for Exploratory Data Analysis. These one or more processes may be executed, in one example, at block 230. Further, one or more processes may be executed to communicate the results to a user or another computer system at block 240.

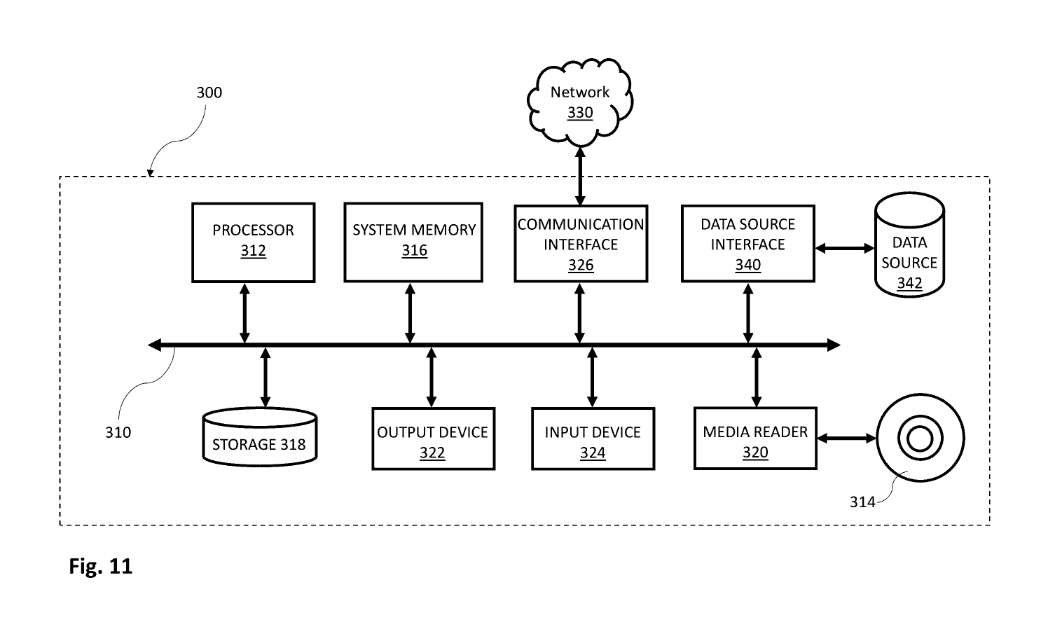

FIG. 11 schematically depicts a block diagram of an exemplary embodiment of a web traffic data cleansing system computing environment 300. I The computing environment 300 may be similar to the application-specific computing device 101 describes in FIG. 1, or may comprise any computing device including a laptop or desktop computer, a server, mobile computing devices or other computing systems. In this exemplary embodiment, the computing system 300 may be interconnected via a bus 310. The computing system 300 includes a processor 312 that executes software instructions or code stored on, for example, a computer readable storage medium 314 or stored in system memory 316, e.g., random access memory, or storage device 318, to perform the web traffic data cleansing processes disclosed herein. The processor 212 can include a plurality of cores. The computing system 300 of FIG. 11 may also include a media reader 320 to read the instructions from the computer readable storage medium 314 and store the instructions in storage device 318 or in system memory 316. The storage device 318 provides storage space for retaining the data, such as the columnar and transposed datasets, and program instructions stored for later execution. Alternately, with in-memory computing devices or systems or in other instances, the system memory 316 may have sufficient storage capacity to store much if not all of the data and program instructions used for the website traffic data cleansing processes of the present disclosure, instead of storing the data and program instructions in the storage device 318. Further, the stored instructions may be further compiled to generate other representations of the instructions and dynamically stored in the system memory 316. In either embodiment, the processor 312 reads instructions from the storage device 318 or system memory 316, and performs actions as instructed.

The computing system 300 may also include an output device 322, such as a display, to provide visual information to certain users, and an input device 324 to permit certain users or other devices to enter data into and/or otherwise interact with the computing system 300. One or more of the output or input devices could be joined by one or more additional peripheral devices to further expand the capabilities of the computing system 300, as is known in the art.

A communication interface 326 may be provided to connect the computing system 300 to a network 330, which may be, for example, a LAN, WAN, an intranet or the Internet, and in turn to other devices connected to the network 330, including clients, servers, data stores, and interfaces where the website traffic data may be collected from various sources 20 (seen in FIG. 1) and transferred to the data cleansing system 50. A data source interface 340 provides access data source 20, typically via one or more abstraction layers, such as a semantic layer, implemented in hardware or software. For example, the data source 20 may be accessed by user computing devices via network 330. The data source may include databases, such as, relational, transactional, hierarchical, multi-dimensional (e.g., OLAP) databases, object oriented databases, and the like. Further data sources may include tabular data (e.g., spreadsheets, and delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC) and the like. The data source can store spatial data used by the real estate data management system of the present disclosure.

While the foregoing disclosure sets forth various embodiments using specific block diagrams, flow diagrams, and examples, each block diagram component, flow diagram step, operation, and/or component described and/or illustrated herein may be implemented, individually and/or collectively, using a wide range of hardware, software, or firmware configurations, or any combination thereof. In addition, any disclosure of components contained within other components should be considered exemplary in nature since many other architectures can be implemented to achieve the same functionality.

Process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

While various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The various embodiments described herein may be implemented by general-purpose or specialized computer hardware. In one example, the computer hardware may comprise one or more processors, otherwise referred to as microprocessors, having one or more processing cores configured to allow for parallel processing/execution of instructions. As such, the various disclosures described herein may be implemented as software coding, wherein those of skill in the computer arts will recognize various coding languages that may be employed with the disclosures described herein. Additionally, the disclosures described herein may be utilized in the implementation of application-specific integrated circuits (ASICs), or in the implementation of various electronic components comprising conventional electronic circuits (otherwise referred to as off-the-shelf components). Furthermore, those of ordinary skill in the art will understand that the various descriptions included in this disclosure may be implemented as data signals communicated using a variety of different technologies and processes. For example, the descriptions of the various disclosures described herein may be understood as comprising one or more streams of data signals, data instructions, or requests, and physically communicated as bits or symbols represented by differing voltage levels, currents, electromagnetic waves, magnetic fields, optical fields, or combinations thereof.

One or more of the disclosures described herein may comprise a computer program product having computer-readable medium/media with instructions stored thereon/therein that, when executed by a processor, are configured to perform one or more methods, techniques, systems, or embodiments described herein. As such, the instructions stored on the computer-readable media may comprise actions to be executed for performing various steps of the methods, techniques, systems, or embodiments described herein. Furthermore, the computer-readable medium/media may comprise a storage medium with instructions configured to be processed by a computing device, and specifically a processor associated with a computing device. As such the computer-readable medium may include a form of persistent or volatile memory such as a hard disk drive (HDD), a solid state drive (SSD), an optical disk (CD-ROMs, DVDs), tape drives, floppy disk, ROM, RAM, EPROM, EEPROM, DRAM, VRAM, flash memory, RAID devices, remote data storage (cloud storage, and the like), or any other media type or storage device suitable for storing data thereon/therein. Additionally, combinations of different storage media types may be implemented into a hybrid storage device. In one implementation, a first storage medium may be prioritized over a second storage medium, such that different workloads may be implemented by storage media of different priorities.

Further, the computer-readable media may store software code/instructions configured to control one or more of a general-purpose, or a specialized computer. Said software may be utilized to facilitate interface between a human user and a computing device, and wherein said software may include device drivers, operating systems, and applications. As such, the computer-readable media may store software code/instructions configured to perform one or more implementations described herein.

Those of ordinary skill in the art will understand that the various illustrative logical blocks, modules, circuits, techniques, or method steps of those implementations described herein may be implemented as electronic hardware devices, computer software, or combinations thereof. As such, various illustrative modules/components have been described throughout this disclosure in terms of general functionality, wherein one of ordinary skill in the art will understand that the described disclosures may be implemented as hardware, software, or combinations of both.

The one or more implementations described throughout this disclosure may utilize logical blocks, modules, and circuits that may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. Functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

What is claimed is:

1. An apparatus, comprising:
a network interface;
a user interface;
a processor;
a non-transitory computer-readable medium comprising computer-executable instructions that when executed by the processor are configured to perform at least:
receiving, from the network interface, a dataset comprising website traffic data in columnar form;
transposing, using a transformer module, the dataset from the columnar form to an analytic dataset;
filtering, using a filter module, low entropy variables from the analytic dataset to provide a filtered analytic dataset;
classifying, using a summarizing engine module, each variable in the filtered analytic dataset to form a classified analytic dataset;
detecting, using a detector module, duplicate variables and correlated variables, in the classified analytic dataset; and
outputting to the user interface, using a reporting engine module, the classified analytic dataset to a user.

2. The apparatus of claim 1, wherein the transposing the dataset from the columnar form to the analytic dataset comprises performing a piecewise transpose process on the dataset comprising website traffic data in the columnar form, wherein the piecewise transpose process further comprises arranging each row in the columnar dataset as a separate column, and performing a horizontal combine wherein each separate column from the piecewise transpose process is arranged as a row to form the analytic dataset.

3. The apparatus of claim 1, wherein the filtering, using the filter module, of low entropy variables comprises analyzing the analytic dataset, determining that a variable has insufficient entropy, and removing the variable from the analytic dataset.

4. The apparatus of claim 3, wherein the variable is determined to have insufficient entropy when it does not have at least two distinct values.

5. The apparatus of claim 1, wherein the classifying, by the summarizing engine module, of each variable in the filtered analytic dataset further comprises processing each variable to determine a frequency distribution for variable element values, and classifying each variable as continuous or categorical based upon a number of bins in the frequency distribution when compared to a categorical threshold parameter value.

6. The apparatus of claim 1, wherein the detecting, using the detector module, of duplicate variables and correlated variables comprises determining correlation coefficients of frequency distributions to establish variable colinearity and comparing the distributions to potential matches.

7. A method for cleansing website traffic data comprising:
transposing a columnar dataset to an analytic dataset for row based data processing;
filtering low entropy variables from the analytic dataset to provide a filtered analytic dataset;
classifying each variable in the filtered analytic dataset to form a classified analytic dataset; and
detecting duplicate variables and correlated variables in the classified analytic dataset.

8. The method for cleansing website traffic data according to claim 7, further comprising:
reporting results in the classified analytic dataset.

9. The method for cleansing website traffic data according to claim 7, wherein transposing a columnar dataset comprises performing a piecewise transpose process on the columnar dataset, wherein each row in the columnar dataset is arranged as a separate column, and performing a horizontal combine wherein each separate column from the piecewise transpose process is arranged as a row to form the analytic dataset.

10. The method for cleansing website traffic data according to claim 7, wherein filtering low entropy variables comprises analyzing the analytic dataset one variable at a time to remove variables determined to have insufficient entropy from the analytic dataset.

11. The method for cleansing website traffic data according to claim 10, wherein a variable having insufficient entropy comprises a variable that does not have at least two distinct values.

12. The method for cleansing website traffic data according to claim 7, wherein classifying each variable in the filtered analytic dataset comprises processing each variable to determine a frequency distribution for variable element values, and classifying each variable as continuous or categorical depending upon a number of bins in the frequency distribution when compared to a categorical threshold parameter value.

13. The method for cleansing website traffic data according to claim 7, wherein detecting duplicate variables and correlated variables comprises determining correlation coefficients of frequency distributions to establish variable colinearity and comparing the distributions with potential matches.

14. A non-transitory computer-readable storage medium comprising computer-executable instructions that when executed by a processor are configured to perform:
receiving, from a network interface, a dataset comprising website traffic data in columnar form;
transposing, using a transformer module, the dataset from the columnar form to an analytic dataset;
filtering, using a filter module, low entropy variables from the analytic dataset to provide a filtered analytic dataset;
classifying, using a summarizing engine module, each variable in the filtered analytic dataset to form a classified analytic dataset;
detecting, using a detector module, duplicate variables and correlated variables, in the classified analytic dataset; and
outputting, using a reporting engine module, the classified analytic dataset to a user.

15. The non-transitory computer-readable storage medium of claim 14, wherein the transposing the dataset comprising website traffic data in the columnar form to the analytic dataset comprises performing a piecewise transpose process on the columnar dataset, wherein the piecewise transpose process further comprises arranging each row in the columnar dataset as a separate column, and performing a horizontal combine wherein each separate column from the piecewise transpose process is arranged as a row to form the analytic dataset.

16. The non-transitory computer-readable storage medium of claim 14, wherein the filtering, using the filter module, of low entropy variables comprises analyzing the analytic dataset, determining that a variable has insufficient entropy, and removing the variable from the analytic dataset.

17. The non-transitory computer-readable storage medium of claim 16, wherein the variable is determined to have insufficient entropy when it does not have at least two distinct values.

18. The non-transitory computer-readable storage medium of claim 14, wherein the classifying, by the summarizing engine module, of each variable in the filtered analytic dataset further comprises processing each variable to determine a frequency distribution for variable element values, and classifying each variable as continuous or categorical based upon a number of bins in the frequency distribution when compared to a categorical threshold parameter value.

19. The non-transitory computer-readable storage medium of claim 14, wherein the detecting, using the detector module, of duplicate variables and correlated variables comprises determining correlation coefficients of frequency distributions to establish variable colinearity and comparing the distributions to potential matches.

20. The non-transitory computer-readable storage medium of claim 14, wherein the outputting the classified analytic dataset to the user comprises outputting the dataset to a user interface.
